(19) United States
(12) Patent Application Publication
(10) Pub. No.: US 2019/0230416 A1
(43) Pub. Date: Jul. 25, 2019

(54) Face Expression Bookmark

(71) Applicant: Guangwei Yuan, Fort Collins, CO (US)

(72) Inventor: Guangwei Yuan, Fort Collins, CO (US)

(73) Assignee: Guangwei Yuan, Fort Collins, CO (US)

(21) Appl. No.: 16/194,337

(22) Filed: Nov. 17, 2018

Related U.S. Application Data
(60) Provisional application No. 62/619,908, filed on Jan. 21, 2018.

(51) Int. Cl. H04N 21/472; G06K 9/00; G06F 3/01

(52) U.S. Cl. CPC H04N 21/47217; G06F 3/011; G06K 9/00302

(57) ABSTRACT

Face expressions can be used as bookmarks for eBooks, videos streams (movies, TV episodes, advisements, news reports, and online games). It's a nonintrusive input method in contrast to text or voice bookmark inputs. It can be very convenient for users to track favorite contents in eBooks, or scenes in videos streams.

### TECHNICAL DETAILS

There is an application to use face expressions as bookmarks in eBooks, video streams and games. The traditional way to bookmark on eBooks requires manual input of text. It also be seen in some applications to attach voice clips to eBooks or videos streams as bookmarks. But those bookmarking methods are either inconvenient or intrusive. For example, inputting text requires opening the keypad (such like a touch screen key board on a mobile device). Inputting voice notes (as bookmarks) causes interruption to video stream playback or online game flow.

The new face expression bookmarking provides nonintrusive input method. For eBooks, reader might need to bookmark a paragraph just using their face expressions. Mobile device CCD cameras or 3D true-depth cameras (seen in recent iPhone X) capture users face expressions, and automatically sort the expressions into different categories. For example, if users choose to bookmark an eBook paragraph where they feel happy and simile this paragraph is going to be bookmarked with a smile face. Later on, when users search for all the contents in the eBooks which they favor, they can just browse the face expressions, searching for smile bookmarks. As seen in above, this method does not need manual inputs of text or voices. Its quickly and automatically done by cameras and expression sorting algorithms.

The application can also be very useful in video streams, such like movies and TV episodes' playbacks, advertisements, news reports, and online games. For movies and TV episodes, the face expression bookmarks will help audiences to record their responses to a movie scene or a TV scene. Late on, when the audiences track their favorite scenes, it's going to be very easy just browsing through the bookmarks. Movie and TV makers can also use those data to find out how general audience response to their work, and figure out what filming techniques cause most favorable response from audiences. Another application is real time sport game. The audiences can bookmark their responses to memorable game scenes. Other bookmark methods, like texting, of cause would be very intrusive to the game watching flow. Similarly, in the online video games, the players might want to record their face expressions during the game, without interrupting the game flow.

The other application is to record customer face expressions during an advisement. Video advertisements are often short, in just a few tens of seconds. A lot information is wrapped into the short video. Using face expression bookmark methods, advertisement providers can easily determine what verbal contents or image scenes cause the most attention from potential customers.

To capture face expressions, mobile CCD cameras can be used, or the true-depth cameras can be used as well. The face expression images can be taken at different rate, for example, at 40, 30, 20, 10, 5, 1 or 0.5 frames per second. The expression images are taken into an algorithm and sorted into categories such like, happy, sad, smile, laugh, surprise or cry, etc. For each category, a cartooned bookmark can be used to represent user's original face expression image. The cartooned bookmark can be customized as well.

There are filters to sort face expressions. laugh and cry, happy and sad, or surprised face expressions can be recorded in different scenarios. For example, in a sport game stream, audiences might show happy face expressions when their favorite team is winning, and nervous face expressions when their favorite team is losing.

To determine expression categories, at first, a large set of pre-sorted face expressions data are used. New images are calculated to determine how much correlation to the pre-sorted data. Users also have the options to redefine an expression image's category attribute.

The face expression bookmarks are stored as time series data. The original expression images are also optionally stored based on user's preference. Users can choose to add additional text and voice notes associated with face expression bookmarks.

### DRAWING DETAILS

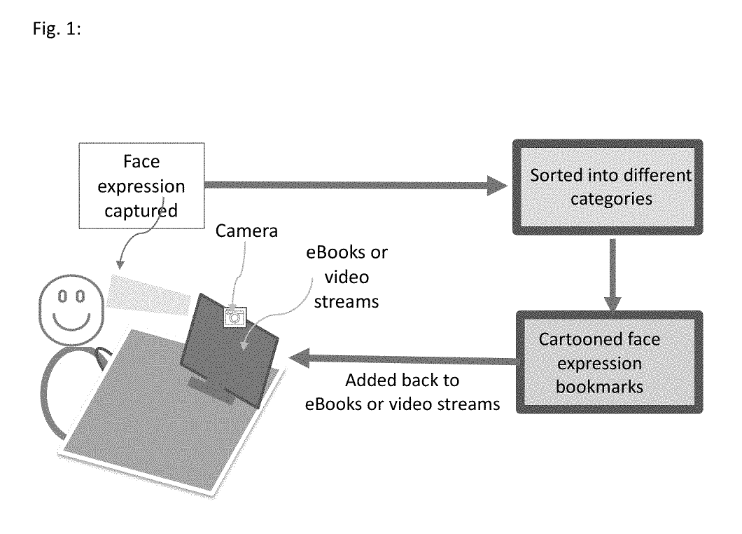

1) FIG. 1. Mobile CCD cameras or 3D true-depth cameras are used to capture the face expression images, back-end algorithms sort face expressions into different categories.

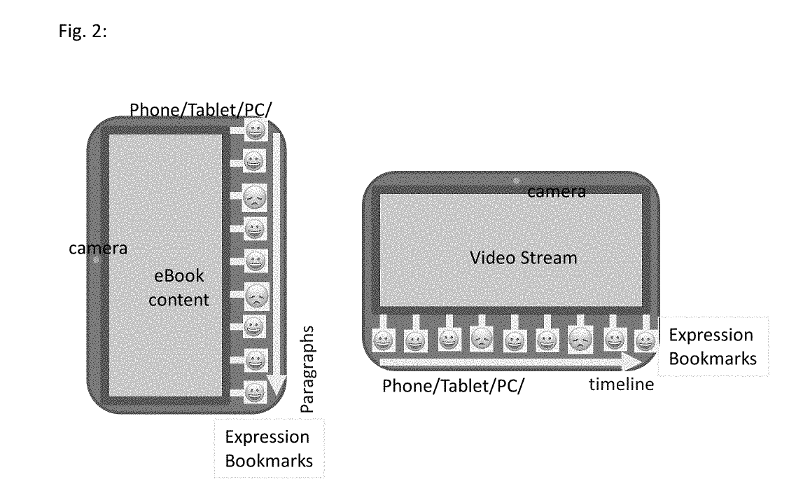

2) FIG. 2. The cartooned face expressions are used as bookmarks in eBooks or videos streams.

1) We claim that face expressions are used as bookmarks for ebooks, videos streams (movies, tv episodes, advisements, news reports, and online games). face expressions are sorted into different categories, for example, happy, sad, surprised, etc. In eBooks, a face expression image is captured and tagged to a certain paragraph of an eBooks. In a videos stream, a face expression image is captured and tagged to a certain scene of video stream. A cartooned bookmark is used to represent the original face expression image.

2) As in claim 1, face expressions are captured by mobile CCD cameras and 3D true-depth cameras. The expressions are captured at 40, 30, 20, 10, 5, 1, 0.5 frames per second.

3) As in claim 1, users search the expression bookmarks using key words such like, happy, surprise. Users also add optional voice and text notes associated to their face expressions.
